(19) United States
(12) Patent Application Publication
(10) Pub. No.: US 2010/0282184 A1
(43) Pub. Date: Nov. 11, 2010

(54) SYSTEM, APPARATUS AND METHOD FOR MONITORING VARIOUS ENVIRONMENTAL CONDITIONS SURROUNDING AN ANIMAL AND COMMUNICATING SAME TO A REMOTE DEVICE

(76) Inventor: Brian LARSON, Hanna (CA)

Correspondence Address: SANDER R. GEISING, 600, 4911-51 STREET, RED DEER, AB, T4N-6V4, CA

(21) Appl. No.: 12/753,871

(22) Filed: Apr. 3, 2010

Related U.S. Application Data
(60) Provisional application No. 61/166,699, filed on Apr. 3, 2009.

(30) Foreign Application Priority Data
Apr. 3, 2009 (CA) 2,661,261

(51) Int. Cl. A01K 27/00; G06F 19/00

(52) U.S. Cl. 119/859; 702/2; 119/863

(57) ABSTRACT

In one aspect the invention provides an apparatus for monitoring environmental conditions and communicating an index value of thereof to a remote device. The apparatus comprises a controller, a temperature sensor operably coupled to the controller and capable of generating a first signal proportional to the temperature condition adjacent said apparatus, a humidity sensor operably coupled to the controller and capable of generating a second signal proportional to the humidity condition adjacent said apparatus and wireless communication means. The controller is responsive to the first and second signals to calculate an index value based thereupon and communicates the index value via the wireless communication means. System and method aspects are also provided.

### CROSS REFERENCE TO RELATED APPLICATION

This application is a regular application of U.S. Provisional Patent Application Ser. No. 61/166,699 filed Apr. 3, 2009 and entitled, “SYSTEM, APPARATUS AND METHOD FOR MONITORING VARIOUS ENVIRONMENTAL CONDITIONS SURROUNDING AN ANIMAL AND COMMUNICATING SAME TO A REMOTE DEVICE”, the entirety of which is incorporated herein by reference.

### FIELD OF THE INVENTION

The present invention relates generally to a monitoring and communication system and, more particularly, to a monitoring and communication system to check the environmental conditions near or surrounding a pet or other animal.

### BACKGROUND OF THE INVENTION

It is common knowledge that pets and other animals are often left unattended or unsupervised in confined spaces, in small enclosures or in some other restrained manner. Examples include dogs or other pets left in a motor vehicle outside a shopping mall, inside a kennel or tied up in a back yard. These animals are then subject to the great variations in localized micro climate conditions that may occur.

For example, a car's windows act like a greenhouse, trapping heat and, in warm weather the vehicles interior temperature can quickly rise to dangerous levels. The inventor is aware of a study funded by General Motors of Canada which found that the internal temperature of a vehicle can exceed 65.5 degrees Celsius (150 degrees Fahrenheit) in just 40 minutes.

The human body normally cools itself by perspiration, or sweating, which evaporates and carries heat away from the body. However, when the relative humidity is high, the evaporation rate is reduced, so heat is removed from the body at a lower rate causing it to retain more heat than it would in dry air. In the United States, the heat index (HI) is an index that combines air temperature and relative humidity in an attempt to determine the human-perceived equivalent temperature—i.e. a better indicator of how hot it feels. The humidex is a measurement used by Canadian meteorologists to reflect the combined effect of heat and humidity. It differs from the heat index used in the United States in using dew point rather than relative humidity. According to the Meteorological Service of Canada, for humans a humidex of at least 40 causes “great discomfort” and above 45 is “dangerous.” When the humidex hits 54, heat stroke is imminent.

Animals such as dogs are at a disadvantage compared to humans, in that the primary way that they can rid themselves of excess body heat is by panting. The air that a dog breathes out is typically at 39 degrees Celsius (102 degrees Fahrenheit) with close to 100% humidity. As such, the humidity of a dog's breath may then act to increase the humidity of the confined space, such as that inside a car, thereby quickly raising the heat index and humidex values; even though the temperature increases alone are much more moderate and gradual.

U.S. Pat. No. 6,693,535 to Van Bosch, et al. which is herein incorporated by reference in its entirety, addresses some of these concerns and teaches a passenger compartment monitoring and control system for remote control of an undesirable condition inside a vehicle, such as the temperature of the interior of the vehicle or the presence of elevated carbon monoxide inside the vehicle. Although this system addresses some of the concerns with leaving an animal unattended in a confined space, the invention of Van Bosch, et al. is restricted to be used with a vehicle only and would therefore not function when an animal is confined in a kennel or carrier or when an animal is restrained by being tied up in a back yard.

Furthermore, Van Bosch, et al. teaches a moisture sensor operative to sense exterior moisture (for inclement weather) which, when present will then actuate the system to reduce any opening of the vehicle's windows or even close them fully (so as to protect the vehicle's interior from water damage). As such, the system of Van Bosch, et al. does not address the concerns that might arise with quickly raising humidity levels (inside a confided space) due to the panting activities of an animal, and thereby could give the user of this system a false sense of security—i.e. showing only a gradual temperature rise, being oblivious to a rapid rise in interior humidity levels and, hence, a rapid rise in the humidex/heat index values that are probably more indicative of the actual internal conditions. Moreover, by triggering the system to close any windows, e.g. should a brief summer thunderstorm pass over, the system of Van Bosch, et al. acts to trap animal generated humidity inside the vehicle (further increasing the adverse conditions inside).

Accordingly, there still exists a need to for an improved system that addresses these disadvantages.

### SUMMARY OF THE INVENTION

The present invention is directed to overcoming the prior art deficiencies in monitoring systems for monitoring of undesirable environmental conditions, including disadvantages in relation to the lack of portability of such systems and in obtaining accurate information regarding actual environmental condition changes.

In one aspect the invention provides a monitoring and communication system for checking the environmental conditions adjacent an animal, comprising: an animal module having a controller, a temperature sensor to generate a first signal proportional to the temperature condition adjacent the animal module and a humidity sensor to generate a second signal proportional to the humidity condition adjacent the animal module, wherein said temperature sensor and said humidity sensor are each operably coupled to the controller and wherein the controller is responsive to the first and second signals to calculate an index value based thereupon, and a remote transceiver, wherein the animal module and the remote transceiver are capable of engaging in wireless communication with each other and the remote transceiver is capable to receive said calculated index value.

In another aspect the invention provides an apparatus for monitoring environmental conditions and communicating an index value of thereof to a remote device, said apparatus comprising: a controller, a temperature sensor operably coupled to the controller and capable of generating a first signal proportional to the temperature condition adjacent said apparatus, a humidity sensor operably coupled to the controller and capable of generating a second signal proportional to the humidity condition adjacent said apparatus, and wireless communication means, wherein the controller is responsive to the first and second signals to calculate an index value based thereupon and communicate said index value of said wireless communication means. Method aspects are also provided.

### BRIEF DESCRIPTION OF THE DRAWINGS

Embodiments of the invention will now be described, by way of example only, with reference to the accompanying drawings, wherein:

FIG. 1 is a diagrammatic view of the monitoring and communication system in accordance with an embodiment of the present invention;

FIG. 2 are electrical schematics of the major electronic components of monitoring and communication system of one embodiment of a system aspect in accordance with an embodiment of the present invention;

FIG. 3 is a flow chart of the major steps executed by the monitoring and communication system of the embodiment of system of FIG. 1 in accordance with an embodiment of the present invention;

FIGS. 4a and 4a are perspective views of the mobile station and the animal module components, respectively, of the embodiment of system of FIG. 1 in accordance with an embodiment of the present invention;

FIG. 5 is a diagrammatic view of one embodiment of the case component, being generally in the shape of a small cell phone;

FIGS. 6a and 6b are diagrammatic front and rear views, respectively, of another embodiment of the case component, being generally in the shape of a small dog bone and having a magnet attached to the rear wall thereof;

FIG. 7 is a perspective view of the animal module shown fastened to an animal using the securing means; and

FIG. 8 is a side view of one embodiment of a conventional quick attach/detach swivel snap that is suitable to attach the case of the system to an animal collar or to another attachment point inside the animal's confined space.

### DETAILED DESCRIPTION OF THE PREFERRED EMBODIMENTS

The following description is of a preferred embodiment by way of example only and without limitation to the combination of features necessary for carrying the invention into effect. Reference is to be had to the Figures in which identical reference numbers identify similar components. The drawing figures are not necessarily to scale and certain features are shown in schematic form in the interest of clarity and conciseness.

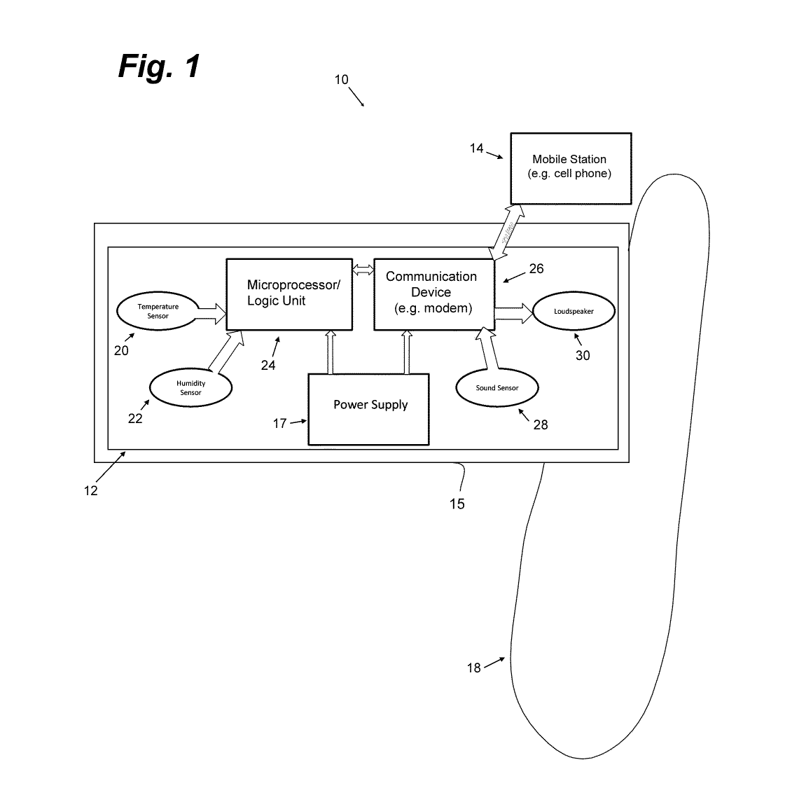

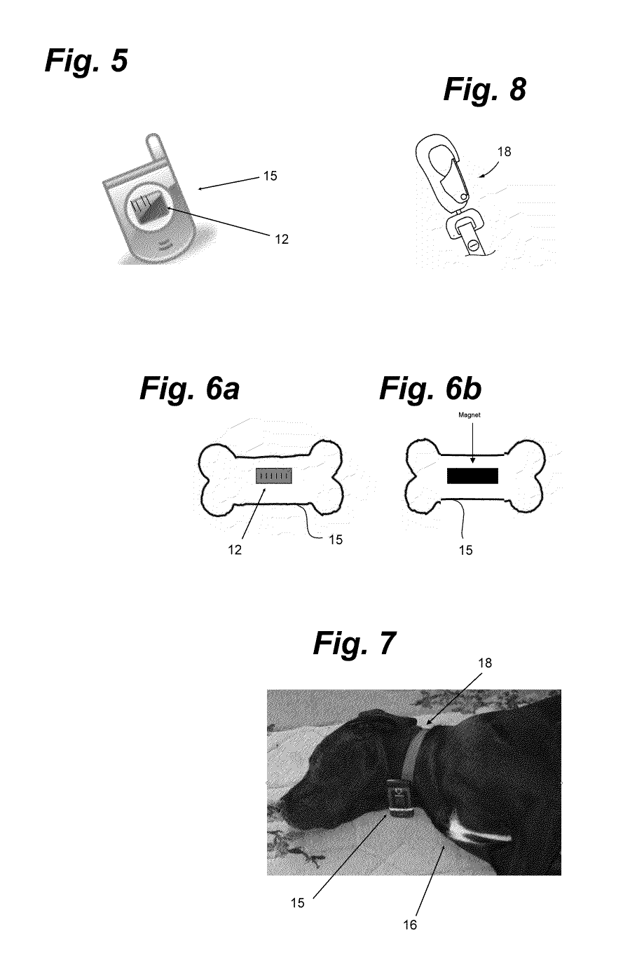

FIGS. 1-5 and 7 illustrate the configuration of a preferred embodiment of a monitoring and communication system 10 of the present invention, for checking the environmental conditions adjacent or surrounding a pet, which provides communication between an animal monitoring and control system 12 and a remote transceiver, device or mobile station 14 such as a cell phone. The animal monitoring and control system 12 will also be referred to as the animal module 12 or animal module apparatus 12 and is preferably portable and placed inside a case 15 so as to provide protection to the electronic components that comprise the animal module. The case 15 may be made in any suitable shape, including amusing shapes such as a cell phone (see FIG. 5) or a dog bone (see FIGS. 6a and 6b) that provide visual appeal so as to encourage use of the system 10.

Animal module 12 has a power supply 17, preferably of sufficient capacity to allow the system 10 to operate for 6-8 hours. Preferably power supply 17 is rechargeable and animal module 12 further comprises a charger port (not shown). Even more preferably, power supply 17 is a 7.4v lithium ion battery such as the B-9592 Camera battery sold under the trade-mark HI-CAPACITY™. In one embodiment of the present invention, the system 10 is always enabled. In another embodiment, a system user can enable system 10 when desired, thereby reducing power consumption when the system user is with the animal 16 and the system's features are not needed. In yet another embodiment, the system 10 is initially in a low-power setting and will be fully enabled upon an incoming cell phone call from the mobile station 14 into the animal module 12 via the communications device 26.

Preferably, the animal module 12 is secured to an animal 16 using securing means 18. The securing means 18 in the preferred embodiment shown in FIGS. 1-5 and 7 comprises a conventional animal collar to which the animal module 12 is securely fastened in a conventional manner, such as by means of small Velcro™ strap, a quick attach/detach swivel snap, a clip or as a permanent glued connection that secures the case 15 to the animal collar.

In an alternate embodiment, the animal module 12 is placed near the animal 16, and inside the confined space that the animal is restricted to, using securing means 18. In the embodiment of FIGS. 6a and 6b, the securing means 18 comprises a magnet incorporated into the design of the case 15. The animal module 12 is thereby able to cling to metal surfaces such as that of a fridge in a motor home.

In another embodiment (not shown), the securing means 18 is a quick attach/detach swivel snap (such as the snap shown in FIG. 8) that functions to link the case 15 to a suitable attachment point inside the confined space such as to the inside bars of a pet carrier or to a chain link fence on a kennel. In such an embodiment, the quick attach/detach swivel snap can, advantageously, secure the case 15 to either a ring on an animal collar (almost every dog collar has a ring for leash attachment) or to a suitable attachment point inside the confined space that the animal is restricted to—providing the user of the system 10 with great portability and flexibility as to where the system 10 can be used. In another embodiment (not shown), the animal module 12 is incorporated into an animal collar and forms a part thereof.

Advantageously, the system 10 may be useful in a large range of environments in which an animal 16 is left unattended, such as the interior of a vehicle, inside a home, locked in a crate or carrier, tied in the back yard, in the back of a truck or in a recreation vehicle such as a motor home, and with a large range of animals or pets (not all of which may have a collar), including exotic birds.

The remote transceiver or mobile station 14 can be any communication device capable of engaging in a wireless communication with the animal module 12, such as a pager, a cellular telephone, a radiotelephone, or a wireless modem coupled to a data processing device such as a personal computer (PC). Preferably the wireless communication is a radio frequency (RF) communication. More preferably the wireless communication is via cell phone technology which utilizes a GSM modem within the animal module 12. However, those who are of ordinary skill in the art realize that the wireless communication may be any kind of wireless communication, such as an optical communication utilizing optical transmitters and receivers, without departing from the spirit and scope of the present invention.

Animal module 12 further comprises a temperature sensor 20 and a humidity sensor 22 that are each operably coupled to a controller 24. Controller 24 is preferably a microprocessor, a microcontroller, or a digital signal processor (DSP) and includes processing power sufficient to support real-time information, communications (including audio/cell phone communications) and humidex or heat index computations applications for the system 10. In the embodiment of FIGS. 1-5 and 7, controller 24 is operably coupled to a communications device 26. More preferably, communications device 26 is a GSM modem. In another embodiment (not shown), controller 24 itself is capable of wireless communications.

Temperature sensor 20 and humidity sensor 22 are each an analog or digital device that generates an electrical signal respectively proportional to the temperature and moisture conditions adjacent the animal module 12. Advantageously, by placement of the animal module 12 off of an animal's collar or inside the confined space that the animal is restricted to, the system 10 is able to sense both temperature and moisture levels and, further, calculate dew point, relative humidity and an index value (such as a humidex or heat index) based thereupon in real time. In another embodiment (not shown), the humidity sensor is replaced with a wind speed sensor and the animal module 12 (and controller therein 24) is programmed to calculate a wind chill index (WCI) instead of a head index.

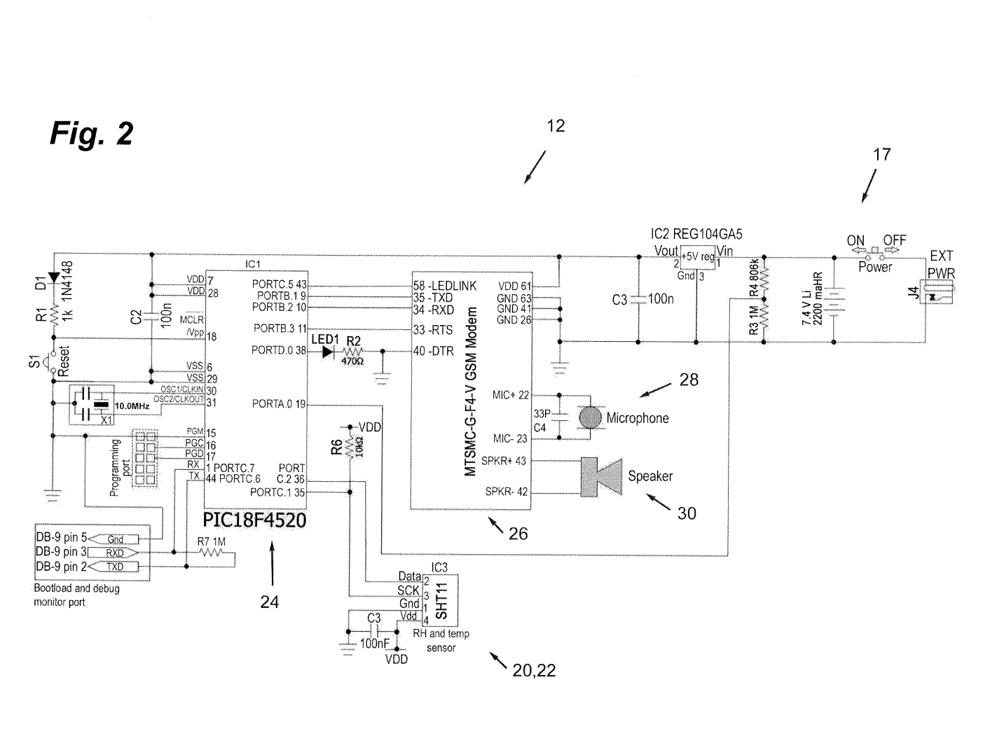

Those who are of ordinary skill in the art realize that there are many means for sensing temperature, wind speed and humidity that may be used herein without departing from the spirit and scope of the present invention. One embodiment of an electrical schematic of the major electronic components of monitoring and communication system 10 is shown in FIG. 2.

Preferably, animal module 12 further comprises a sound (audio) sensor 28 (to allow the system 10 to monitor for animal sounds, such as barking) and a sound output device 30 such as a speaker (to allow a user to call the animal module 12 and have it broadcast the user's voice, so as to “talk to” or reassure the animal 16, issue commands, etc.). More preferably, the system 10 is programmed to provide a set interval of listening and/or talking time (e.g. 1 minute of “live” audio) so that the user can communicate with the animal 16. One suitable sound sensor 28 is the electret condenser microphone manufactured by CUI Inc. of Tualatin, Oreg., U.S.A. under part number CMR-2747PB-A.

Even more preferably, animal module 12 further comprises one or more memory devices (not shown) coupled to controller 24, such as a flash memory and a random access memory (RAM), for storing data, parameters, commands, computational codes for calculating index values based on temperature and humidity values (e.g. humidex or heat index), information and user inputs. Even more preferably, animal module 12 further comprises a Global Positioning System (GPS) unit (not shown) having a GPS receiver. Advantageously, a GPS unit provides tracking capability so that when the animal module 12 is attached at a collar, an animal 16 can be tracked if it escapes or becomes lost. Any one or more of temperature sensor 20, humidity sensor 22, communications devices 26, sound sensor 28, sound output device 30 and GPS unit may be coupled to controller 24 via a vehicle bus (not shown) or a device bus (not shown).

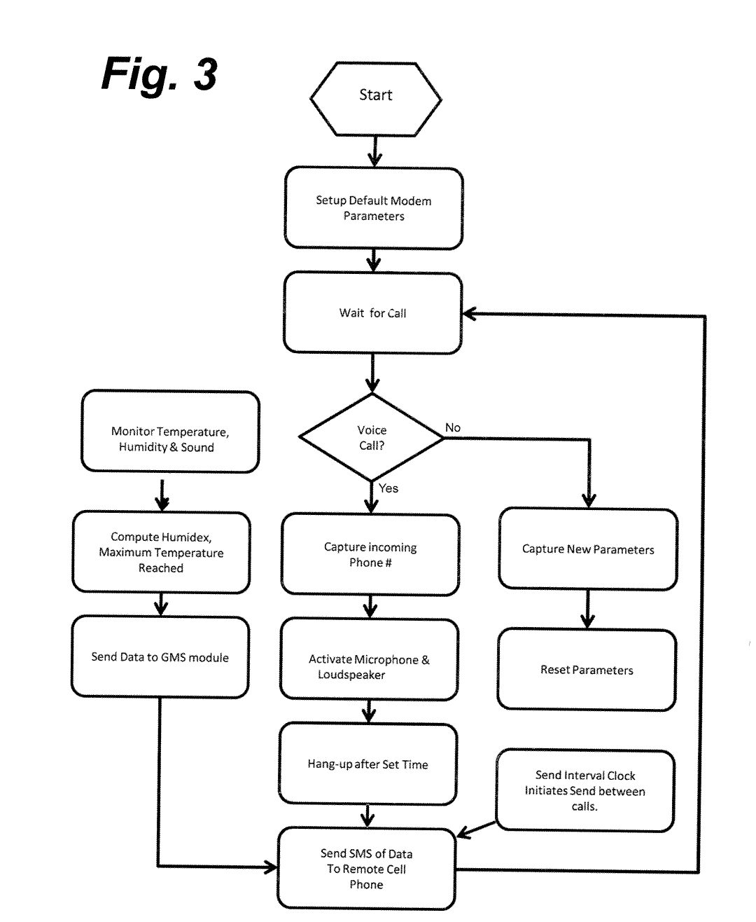

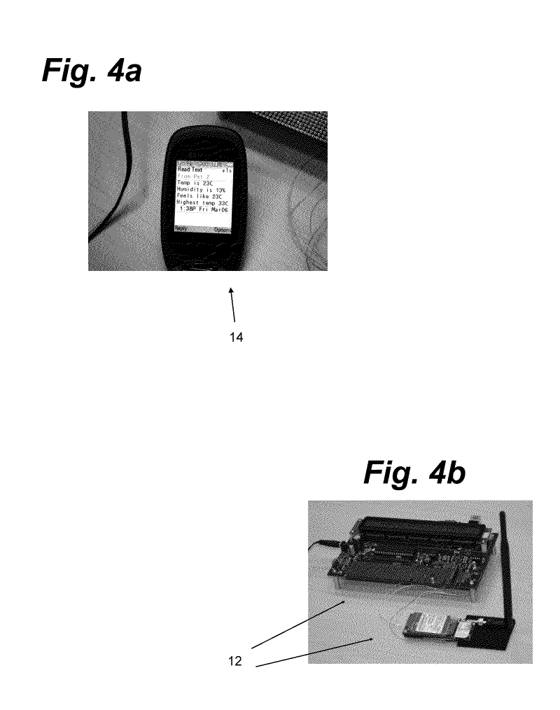

Preferably once engaged, controller 24 is programmed to query the user for certain inputs and parameters via a user interface. The user interface may be through the mobile station 14 (see FIG. 4a) via a data (non-voice) call (see FIG. 3) or through by connecting the controller 24 to a personal computer (PC), such as through a WiFi connection, a BLUETOOTH™ connection or via USB cable connection. For example, the user may be asked to input temperature levels, humidity levels or index thresholds (e.g. humidex or heat index) at which the system 10 will activate to send relevant data and warnings to the mobile station 14. Advantageously, a user can consult with their animal health care practitioner (e.g. veterinarian) to determine the particular levels (e.g. humidex values) suitable for their animal 16, preferably based on the animals size, weight, age, general health and thickness of fur.

Once the data has been input, controller 24 stores this information in memory for future reference (e.g. see the “Capture New Parameters” and “Reset Parameters” boxes in FIG. 3). Those of ordinary skill in the art realize that a memory device other than a RAM may be employed for this function without departing from the spirit and scope of the present invention.

In yet another embodiment of the present invention, system 10 may be programmed at the factory with default settings for the input parameters. As a result, system 10 may include a default mode where the user would not need to enter any data. The user would simply arm or engage system 10 according to pre-programmed factory settings upon start-up of the animal module 12 and the system would use the factory default data during operation (e.g. see the “Setup Default Modem Parameter's” box in FIG. 3). In the embodiment of FIG. 3, there is a default mode wherein the initial parameters can then be subsequently changed via a non-voice call (i.e. a data call) into the control unit 24.

When enabled, system 10 operates automatically, preferably until disabled by the user (alternatively for a pre-set length of time), to monitor temperature sensed by temperature sensor 20 and humidity levels detected by humidity sensor 22 and to compute an index value (e.g. humidex or heat index) based thereon.

In one embodiment, when an elevated temperature, humidity or (more likely) index value is detected, or computed, by the animal module 12, the system 10 can initiate and engage in a wireless communication with the user's mobile station 14 via communication device 26, preferably via Short Message Service (SMS) using the GSM mobile communication system 26 and using standardized communications protocols, to display short text messages on the mobile station 14 (e.g. see. FIG. 4a).

In another embodiment or aspect, the system 10 will measure temperature and humidity and will calculated an index value thereof (e.g. humidex) at preset intervals and will then initiate and engage in wireless communication with the user's mobile station 14 to display the most recent temperature, humidity and index (e.g. humidex) values which their pet is experiencing at any given time. Advantageously, the system's user will be comforted by periodic updates of these values and know that they are within acceptable ranges. Preferably, a default interval (e.g. 15 minutes) will initially be used, with the user will having the ability to program a different interval by phoning/texting the animal module 12.

In one embodiment, the system 10 is programmed to call a particular mobile station 14 upon initial set up. Preferably, however, the systems' communication device 26 has its own phone number that can be called from any cell phone and has an auto-answer feature. Upon calling the communication device 26, the system's programming will “capture” the incoming phone number, hang up, measure temperature and humidity values, calculate index values based thereupon, call the captured incoming phone number back and send back a message with the environmental conditions as previously described. Subsequent wireless communication updates will then be sent to this captured phone number. Advantageously, the system 10 can be accessed by the user using a third party's cell phone.

In yet another embodiment, a pin or security code will be programmed into the system 10 before it will be triggered to capture the incoming phone number and use that for further wireless communications. Advantageously, an individual accidentally calling the system 10 will not be able to interact with it.

Those of ordinary skill in the art will appreciate that various modifications to the invention as described herein will be possible without falling outside the scope of the invention.

The embodiments of the invention in which an exclusive property or privilege is being claimed are defined as follows:

1. A monitoring and communication system for checking the environmental conditions adjacent an animal, comprising:
an animal module having a controller, a first sensor to generate a first signal proportional to a first environmental condition adjacent the animal module and a second sensor to generate a second signal proportional to a second environmental condition adjacent the animal module, wherein said first sensor and said second sensor are each operably coupled to the controller and wherein the controller is responsive to the first and second signals to calculate an index value based thereupon; and
a remote transceiver,
wherein the animal module and the remote transceiver are capable of engaging in wireless communication with each other and the remote transceiver is capable to receive said calculated index value.

2. The system of claim 1, wherein the controller is capable to calculate said index value in real time.

3. The system of claim 1, wherein the animal module further comprises an audio sensor and a sound output device operably coupled to the controller so as to enable both the remote monitoring of animal sounds and the broadcasting of a user's voice to the animal module, via the remote transceiver.

4. The system of claim 1, wherein the animal module further comprises a global positioning system operably coupled to the controller so as to enable remote tracking of said animal module via the remote transceiver.

5. The system of claim 1, wherein the animal module is portable and further comprises a case for placement of the animal module therein.

6. The system of claim 5, further comprising securing means to secure the animal module to the animal.

7. The system of claim 6, wherein the securing means is an animal collar.

8. The system of claim 6, wherein the securing means comprises a magnet incorporated into the case.

9. The system of claim 6, wherein the securing means is a quick attach/detach swivel snap.

10. The system of claim 1, wherein the controller is capable of receiving user inputted index thresholds and, when said thresholds are reached, said controller will send a message to the remote transceiver.

11. The system of claim 1, wherein the first sensor is a temperature sensor, the second sensor is a humidity sensor and the calculated index value is expressed as a heat index value.

12. An apparatus for monitoring environmental conditions and communicating an indicator thereof to a remote device, said apparatus comprising:
a controller;
a first sensor operably coupled to the controller and capable of generating a first signal proportional to a first environmental condition adjacent said apparatus;
a second sensor operably coupled to the controller and capable of generating a second signal proportional to a second environmental condition adjacent said apparatus; and
wireless communication means,
wherein the controller is responsive to the first and second signals to calculate an index value based thereupon and communicate said index value to said wireless communication means.

13. The apparatus of claim 12, wherein the controller is also the wireless communication means.

14. The apparatus of claim 12, further comprising an audio sensor and a sound output device operably coupled to the controller so as to enable both the remote monitoring of animal sounds and the broadcasting of a user's voice to the apparatus, via a the remote device.

15. The apparatus of claim 12, further comprising a global positioning system operably coupled to the controller so as to enable remote tracking of said apparatus via the remote device.

16. The apparatus of claim 12, wherein said apparatus is portable and further comprises a case for placement of the animal module therein.

17. The apparatus of claim 16, further comprising securing means to secure it to an animal.

18. The apparatus of claim 17, wherein the securing means is an animal collar.

19. The apparatus of claim 17, wherein the securing means comprises a magnet incorporated into the case.

20. The apparatus of claim 17, wherein the securing means is a quick attach/detach swivel snap.

21. The apparatus of claim 12, wherein said apparatus is incorporated into an animal collar.

22. The apparatus of claim 12, wherein the controller is capable of receiving user inputted index thresholds and, when said thresholds are reached, said controller will send a message to the remote device.

23. The apparatus of claim 12, wherein the first sensor is a temperature sensor, the second sensor is a humidity sensor and the calculated index value is expressed as a heat index value.

24. A method for monitoring an environmental condition adjacent an animal, the method comprising steps of:
providing the apparatus of claim 12;
securing said apparatus adjacent an animal; and
using said apparatus to calculate said index value.

25. The method of claim 24, further comprising the step of wirelessly communicating said index value to a remote device.
